(19) United States
(12) Patent Application Publication
(10) Pub. No.: US 2020/0313154 A1
(43) Pub. Date: Oct. 1, 2020

(54) Rechargeable Battery Electrodes having Optimized Particle Morphology

(71) Applicant: Purdue Research Foundation, West Lafayette, IN (US)

(72) Inventors: Lucas Darby Robinson, West Lafayette, IN (US); Ramiro Edwin Garcia, West Lafayette, IN (US)

(73) Assignee: Purdue Research Foundation, West Lafayette, IN (US)

(21) Appl. No.: 16/809,231

(22) Filed: Mar. 4, 2020

Related U.S. Application Data
(63) Continuation of application No. 15/610,619, filed on May 31, 2017, now abandoned.
(60) Provisional application No. 62/343,640, filed on May 31, 2016.

(51) Int. Cl. H01M 4/02; H01M 10/0525; H01M 4/13

(52) U.S. Cl. CPC H01M 4/02; H01M 10/0525; H01M 2010/4292; H01M 2004/028; H01M 2004/021; H01M 4/13

(57) ABSTRACT

A battery, comprising an anode and a cathode, the cathode comprising particles having an aspect ratio between 0.09 and 0.5. In certain embodiments, the particles are ellipsoidal. The battery may comprise an electro chemical lithium-ion battery structure. Optimal particle microstructure morphologies are identified to deliver high power or energy densities.

### CROSS-REFERENCE TO RELATED APPLICATIONS

The present patent application is a continuation of U.S. patent application Ser. No. 15/610,619, filed May 31, 2017, which claims the priority benefit of U.S. Provisional Patent Application Ser. No. 62/343640, filed May 31, 2016, the contents of which are hereby incorporated by reference in their entirety into the present disclosure.

### TECHNICAL FIELD

The present application relates to electrochemical batteries, and more specifically, to electrodes for rechargeable electrochemical batteries.

### BACKGROUND

In the pursuit of optimizing the reliability and performance in porous rechargeable batteries, it is desirable to manufacture slurries that possess a large reactive area density while simultaneously providing as little ohmic resistance as possible to passing charge-carrying ions. Traditionally, higher energy densities are achieved through the maximization of the amount (or volume fraction) of active material that the electrode can store—a property that is specified by compacting the fabricated electrode layer—leading to an in-plane alignment of the particles, and thus specifying the microstructural properties of the battery. Resultant microstructural properties of the battery include the reactive area density of the particles, which specifies the local power density at a given instant. Conversely, the delivered power density per unit mass is limited by the polarization losses imposed by the tortuosity of the electrode. An increasingly tortuous microstructure suppresses lithium diffusion and resists the access of useful charge to the active material. In both cases, the starting particle morphology, its volume fraction, alignment, and spatial distribution during battery fabrication, specifies the performance and lifetime reliability.

### BRIEF DESCRIPTION OF THE DRAWINGS

In the following description and drawings, identical reference numerals have been used, where possible, to designate identical features that are common to the drawings.

FIG. 1 is a plot showing showing Energy density as a function of Bruggeman exponent, α, and minor to major axis (aspect) ratio for monodispersed, perfectly aligned ellipsoidal particles in a porous cathode. Results indicate that an increase in the Bruggeman exponent induces a sharp drop in energy density near α=6 (aspect ratio of (c/a)˜0.1). In the absence of area density contributions to the transport limitations and intercalation kinetics of rechargeable batteries, increasingly oblate particles exhibit lower energy densities.

FIG. 2a-2d are a plots showing through-thickness overpotential profiles for selected cathode Bruggeman exponents. FIG. 2a shows the case for α=0.5 (a), or for perfectly spherical particles, a voltage drop develops at the separator-cathode interface as a result of the intercalation transient in the front of the cathode. A voltage gradient develops on the side of the anode facing the separator as active material deintercalates. FIG. 2b shows the case for increasing α to 5.5 which results in a larger voltage gradient in the cathode that decreases with increasing time (intercalation). The cathode voltage gradient increases as the back of the cathode stops reacting. FIG. 2c shows the case where a further increase in a induces the voltage drop in the cathode. FIG. 2d shows the case where yet further increase in a induces the voltage drop in the cathode to reach a maximum and thus limit intercalation.

FIGS. 3a-3d are plots showing showing through-thickness Butler-Volmer current density profiles for cathode layers displaying selected Bruggeman exponents, α. FIG. 3a shows the case for α=0.5, where reaction zones propagate from the anode-separator and separator-cathode interfaces towards the backcontact. FIG. 3b shows the case where increasing α to 5.5 shifts the reaction zone starts at cathode-back contact, and propagates towards the separator as the cathode intercalates. FIG. 3c shows the case where a further increase in α moves the reaction zone to the cathode-back-contact interface, thus limiting energy density performance. FIG. 3d shows the case for yet a further increase in α.

FIGS. 4a-4d are plots showing through-thickness normalized solid concentration profiles for various Bruggeman exponents. FIG. 4a shows the case for α=0.5 (a), where deintercalated lithium at the anode is intercalated at the front of the cathode. FIG. 4b shows the case for α=5.5, where the active material intercalation occurs in the back of the cathode, moving towards the front of the layer. FIG. 4c shows the case where increasing α further causes intercalation to be limited to the back of the cathode layer. FIG. 4d shows the case where increasing α still further causes intercalation to be further limited to the back of the cathode layer.

FIGS. 5a-5d are plots showing through-thickness lithium concentration in the electrolyte for various cathode Bruggeman exponents. FIG. 5a shows the case for α 0.5, where lithium is deintercalated from the anode particles into the electrolyte and intercalated into the cathode particles, causing concentration accumulation at the separator-anode interfaces, and depletion in the back of the cathode layer. FIG. 5b shows the case for α=5.5, where a lower average diffusivity in the porous cathode layer maximizes the chances of lithium accumulation and salt precipitation at the anode-separator interface. FIG. 5c shows that a further increase in α stunts the deintercalation process in the back of the anode. FIG. 5d shows that yet a further increase in α limits the representative transport path to reach the active material in the back of the cathode.

FIG. 6 is a plot showing Energy density as a function of particle shape factor, A, and aspect ratio, c/a, for, perfectly aligned ellipsoidal particles in a porous cathode. As the particle shape factor increases, the energy density increases linearly up to a shape factor of A˜24 (aspect ratio of (c/a)˜0.0435), where the energy density becomes constant as a result of the inherent transport limitations of the utilized material parameters.

FIGS. 7a-7d are plots showing electrolyte overpotential distribution for different cathode shape factors. FIG. 7a shows the case for a shape factor of A˜3, or for perfectly spherical particles, a voltage drop develops at the separator-cathode interface as a result of the intercalation transient in the front of the cathode, as described in FIG. 2a. FIG. 7b shows the case for a shape factor of A=13, where voltage gradients at the anode-separator interface extend into the rear of the anode and decrease in time as cathode reactivity increases. FIG. 7c shows where an increase to a particle shape factor to A=23 allows the cathode to develop near-equilibrium voltage gradients in both electrodes. FIG. 7d shows where a further increase to a particle shape factor to A=33 allows the cathode to develop near-equilibrium voltage gradients in both electrodes.

FIGS. 8a-8d are plots showing Butler-Volmer current density profiles for various cathode particle shape factors. FIG. 8a shows the case for a shape factor of A=3, where current density gradients form at the anode-separator and separator-cathode interfaces and propagate to the back of the electrode layer. FIG. 8b shows the case for a shape factor of A=13, where the reaction zone extends throughout the thickness of the anode layer. FIG. 8c shows the case for a shape factor of A=23, where the reaction zone in the cathode is uniformly distributed. FIG. 8c shows the case for a shape factor of A=23, where the reaction zone in the cathode is uniformly distributed. FIG. 8d shows the case for a shape factor of A=33.

FIGS. 9a-9d are plots showing normalized solid concentration profiles for cathode layers displaying selected shape factors. FIG. 9a shows the case for a shape factor of A=3, where concentration at the front of the cathode increases because the reaction zone model is closer to the separator. FIG. 9b shows the case for a shape factor of A=13, where increased reactivity in the cathode drives greater depletion in the anode. FIG. 9c shows the case where further increasing the shape factor results in the full depletion of the anode. FIG. 9d shows the case where still further increasing the shape factor results in the full depletion of the anode.

FIGS. 10a-10d are plots showing Electrolyte concentration profiles for selected shape factors. FIG. 10a shows the case for a shape factor of A=3, where lithium is deintercalated from the anode particles into the electrolyte and intercalated by the cathode particles, causing concentration gradients at the separator-electrode interfaces. FIG. 10b shows the case for a shape factor of A=13, where increased reactivity in the cathode causes more deintercalation in the anode, and thus more accumulation. FIG. 10c shows the case where further increase in the shape factor drives more lithium ions from the anode into the cathode as intercalation increases. FIG. 10d shows the case where still further increases in the shape factor drives yet more lithium ions from the anode into the cathode as intercalation increases.

FIG. 11 is a plot showing macroscopic energy density as a function of particle aspect ratio, α, for monodispersed, perfectly aligned ellipsoidal particles in a porous cathode. Results demonstrate a maximum in the delivered energy density (˜92.9 Wh/kg) for an aspect ratio of (c/a)=0.107. A sharp drop for highly oblate particles highlights the strong impact of through-thickness tortuosity. To the right of the optimal value, the delivered energy density drops due to a decrease in cathode particle reactivity.

FIGS. 12a-12d are plots showing Electrolyte overpotential throughthickness distribution for selected cathode particle aspect ratios. FIG. 12a shows the case for an aspect ratio of (c/a)=0.075, where the cell behaves is limited by the microstructural polarization losses, as shown in FIG. 2b. FIG. 12b shows the case for the optimal aspect ratio of (c/a)=0.107, where the initial polarization losses in both electrode layers are minimized as a result of the optimal reactivity that the cathode layer displays. FIG. 12c shows the case where further increase ion the aspect ratio maximizes the voltage gradients towards the front of the cathode. FIG. 12d shows the case for an aspect ratio of (c/a)=1.0, or perfectly spherical particles, where polarization drops increase as the reaction proceeds, making it non-ideal.

FIGS. 13a-13d are plots showing Butler-Volmer current density profiles for selected cathode particle aspect ratios. FIG. 13a shows that for an aspect ratio of (c/a)=0.075, lithium transport limitations in the cathode localize intercalation in the back contact, as shown in FIG. 3d. FIG. 13b shows the case for an aspect ratio of (c/a)=0.107, where the reaction zone propagates from the back of the cathode to the separator-cathode interface, across a finite range, leading to a wide reaction zone (see FIG. 14b). FIG. 13c shows the case where an increase in the aspect ratio to (c/a)=0.2 causes the reaction zone in the cathode to propagate from the front of the layer to the back contact. FIG. 13d show the case for a further increase in the aspect ratio to (c/a)=1.0.

FIGS. 14a-14d are plots showing Normalized lithium concentration profiles for various cathode particle aspect ratios. FIG. 14a shows the case for an aspect ratio of (c/a)=0.075, where transport limitations result in intercalation to be limited in the back of the cathode layer. FIG. 14b shows the case for an aspect ratio of (c/a)=0.107, where the cathode fills from the back towards the separator across a wide reaction zone, while the anode almost fully deintercalates before the driving force approaches zero (see FIG. 12(b)). FIG. 14c shows the case where an increase in the aspect ratio to (c/a)=0.2 causes intercalation to propagate from the front of the layer to the back contact. FIG. 14d shows the case for an aspect ratio of (c/a)=1.0.

FIGS. 15a-15d are plots showing Electrolyte lithium concentration profiles for selected cathode particle aspect ratios. FIG. 15a shows the case for an aspect ratio of (c/a)=0.075, where concentration behavior is qualitatively similar to the one displayed in FIG. 5(c), i.e., limited by tortuosity. FIG. 15b shows the case for an aspect ratio of (c/a)=0.107, where the lithium concentration accumulation in the anode attempts to be minimized while returning to equilibrium after the initial transient. FIG. 15c shows the case for an increase of aspect ratio to (c/a)=0.2, which decreases the rate of intercalation of lithium in the cathode, while also minimizing the tortuosity. FIG. 15d shows the case for an aspect ratio of (c/a)=1.0.

FIGS. 16a is a plot showing a Ragone plot displaying the effects of particle morphology on the power density behavior. Three main types of response develop high energy density regime, HEDR, 0.09<(c/a)<0.107, high power density, HPDR, (c/a)>0.17, (at the expense of minimizing the delivered energy density), and an intermediate regime, IR, 0.107<(c/a)<0.17, where both the power and energy density are at its highest without sacrificing the other one. FIG. 16b shows that an optimal aspect ratio delivers an optimal energy density response for each current density.

The attached drawings are for purposes of illustration and are not necessarily to scale.

### DETAILED DESCRIPTION

In the following description, some aspects will be described in terms that would ordinarily be implemented as software programs. Those skilled in the art will readily recognize that the equivalent of such software can also be constructed in hardware, firmware, or micro-code. Because data-manipulation algorithms and systems are well known, the present description will be directed in particular to algorithms and systems forming part of, or cooperating more directly with, systems and methods described herein. Other aspects of such algorithms and systems, and hardware or software for producing and otherwise processing the signals involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

The dependence of reactive area density and tortuosity on particle morphology is qualitatively reflected on the dependence of these parameters on the average particle aspect ratio: more oblate particles are intuitively expected to exhibit a higher reactive area density and a higher tortuosity, while more needle-like particles possess a smaller reactive area density and impart less tortuous conditions for diffusion. This qualitatively suggests that an optimal particle aspect ratio and battery microstructure exists such that the mean reactive area density is maximized while the through thickness tortuosity is minimized, resulting in a maximized energy density. In the present disclosure, the optimal particle microstructure morphologies are identified to deliver high power or energy densities. The underlying mechanisms that control the battery performance are identified and rationalized as a stepping stone to propose optimal cathode particle aspect ratios.

The reactive area per unit volume, denoted herein as ρ_{A}, is a direct measure of the power density of an electrode layer. Historically, it is defined as:

$$\begin{matrix}{ρ}_{A} = \frac{4 π {r}_{p}^{2}}{\frac{4}{3} π {r}_{p}^{3}} ( 1 - ɛ ) \\ = \frac{3}{{r}_{p}} ( 1 - ɛ )\end{matrix} \qquad ( 1 )$$

for a distribution of perfectly spherical particles. Here, rₚ is the microstructurally averaged particle radius and ! is the electrode porosity. In general, the average area per until volume is a direct function of the particle morphology, and the polydispersity of the characteristic size, leading to expressions of the form:

$${ρ}_{A} = \frac{{r}_{p}}{} ( 1 - ɛ ) \qquad ( 2 )$$

where A is the shape factor, a quantity that captures the effects of the representative particle geometry, such that A->3 in the limit of perfectly spherical, smooth particles.

For perfectly aligned ellipsoidal particles with principal axes a=b≠c, the shape factor may be expressed in terms of particle aspect ratio, rₐ, by the following set of equations:

$$= \frac{3}{2 {r}_{a}} ( 1 + {r}_{a}^{2} \frac{arc tan [ \sqrt{r \frac{2}{a} - 1} ]}{\sqrt{r \frac{2}{a} - 1}} ) if {r}_{a} > 1 \\ = 2 + \frac{1}{{r}_{a}} if {r}_{a} < 1 \qquad ( 3 )$$

In the limit of rₐ=1 for spherical particles, both components of Eq. 4 approach A=3. In contrast, the through-thickness tortuosity of a porous electrode layer depends on the particle morphology through the Bruggeman relation:

$$τ = \frac{1}{{ɛ}^{α}} \qquad ( 4 )$$

Where α is is the generalized Bruggeman exponent and τ is the ratio of diffusivity in free space to the diffusivity in perfectly homogenous, spatially averaged porous media. In this context, recent work by Garcia and coworkers has analytically defined the effects of microstructure morphology on the average electrode properties in porous rechargeable batteries. Specifically, morphological anisotropy is expressed in terms of an average aspect ratio. For perfectly aligned monodispersed particles, the Bruggeman exponent is specified in terms of the depolarization factor, L:

$$〈 α 〉 = \frac{1 - 2 L}{2 L} \qquad ( 5 )$$

which is a measure of the effect of particle morphology on the internal electric field of a statistically representative particle and dictates the charge flow in the particle vicinity. The depolarization factor is defined as:

$$L = \frac{1}{1 - {r}_{a}^{2}} + \frac{{r}_{a} arc cosh ( {r}_{a} )}{{( {r}_{a}^{2} - 1 )}^{3 / 2}} if {r}_{a} > 1 \\ L = \frac{1}{1 - {r}_{a}^{2}} + \frac{{r}_{a} arc cos ( {r}_{a} )}{{( 1 - {r}_{a}^{2} )}^{3 / 2}} if {r}_{a} < 1 \qquad ( 6 )$$

In one example, an analysis was performed in the Open Source software, dualfoil.py [5-6], a python-based interface that enables the intuitive and hierarchal control of the dualfoil legacy code, as made public by John Newman and coworkers. The resultant output was post-processed by a set of Matplotlib-based visualization modules that provide the user with the ability to rapidly set up complex, multiscale simulations. Further, the dualfoil legacy code was extended to consider arbitrary electrode Bruggeman exponents, α, and shape factors, A, as design adjustable parameters, to capture their individual contributions, and simultaneously assess their impact as determined by their representative aspect ratio and degree of alignment. Specifically, the LiC₆|LiMn₂O₄ system was analyzed. Design adjustable and material parameters are displayed in Table 1 below

TABLE 1
Design Adjustable and Material Parameters

| Parameter | LiₓC₆ | Li_{y}Mn₂O₄ |
|---|---|---|
| δ (μm) | 100 | 174 |
| ε_{liq} | 0.357 | 0.444 |
| ε_{poly} | 0.146 | 0.186 |
| ε_{fill} | 0.026 | 0.076 |
| rₚ (μm) | 12.5 | 8.5 |
| ρₛ (g/cm²) | 4.4 | 1.9 |
| Dₛ (cm²/s) | 3.9 × 10⁻¹⁰ | 1.0 × 10⁻⁹ |
| σ₀ (S/cm) | 1.0 | 0.038 |
| i₀ (mA/cm²) | 0.11 | 0.08 |
| cₜ (mol/dm³) | 26.39 | 22.86 |
| cₛ⁰ (mol/dm³) | 14.87 | 3.90 |

| Parameter | Value |
|---|---|
| δₛ (μm) | 52 |
| c₀ (mol/m3) | 2000 |
| T (° C.) | 25 |
| p | 3.3 |
| ρ_{I} (g/cm³) | 1.324 |
| ρ_{P} (g/cm³) | 1.780 |

Material parameters used hereon are identical to those widely used and validated by Doyle and coworkers, and widely used in the literature by authors such as Arora et al., which uses equivalent design adjustable parameters, against a wide range of equally validated battery systems. For the individual Bruggeman exponent and shape factor parameters analysis, simulated cells were discharged at 22.5 A/m2, in order to assess the effects varying Bruggeman exponents and shape factors. The Bruggeman exponent analysis comprised 24 simulations that varied the cathode particle Bruggeman exponent, α, from 0.5 (spherical) to 12 (oblate) by at intervals of 0.5 (spherical). Each simulation took on the order of 4 minutes of wall time. The shape factor analysis comprised 40 simulations that varied the cathode particle shape factor from 1 (prolate) to 40 (oblate). The effect of particle morphology aspect ratio (herein denoted as the minor axis to major axis ratio, c/a) was quantified by numerically implementing Equations 4 through 6, which directly relate the c/a-ratio to the Bruggeman exponent and the particle area density. The cathode particle aspect ratio was varied from 0.075 to 1 (spherical) at intervals of 0.001. The discretization of the analyzed range of parameter values was further refined in those aspect ratio regimes that exhibits improved cell performance.

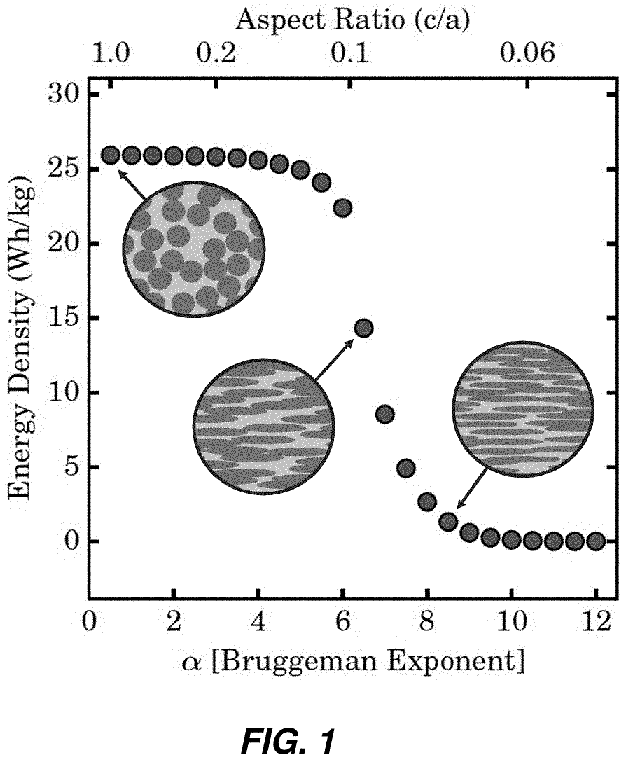

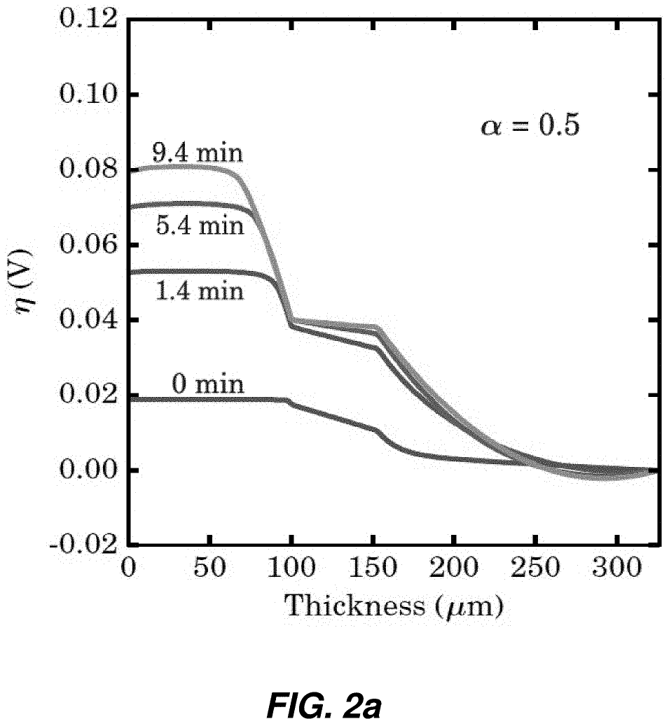

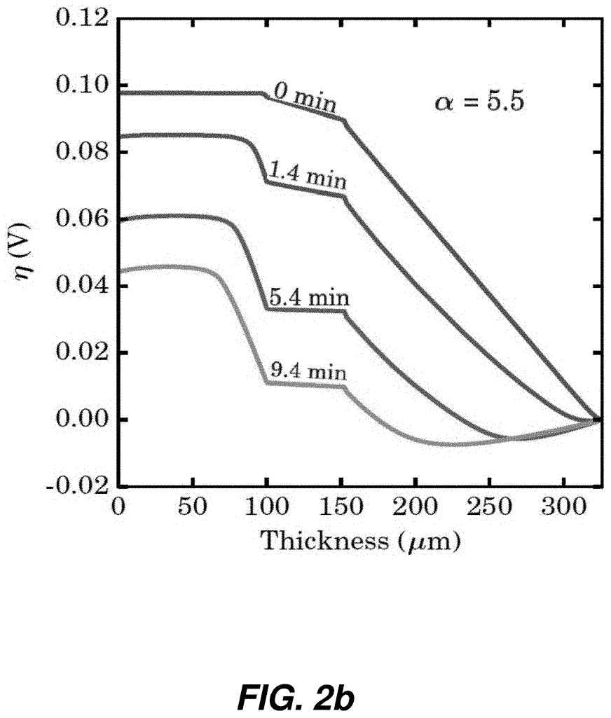

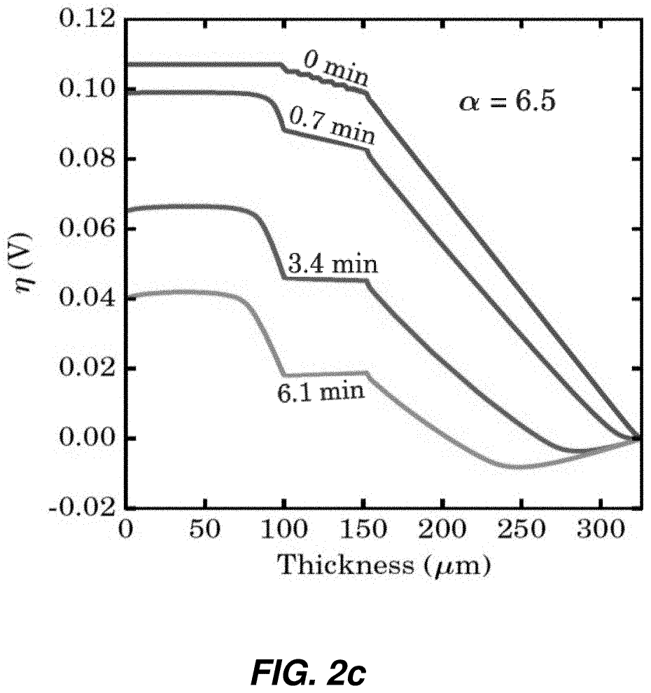

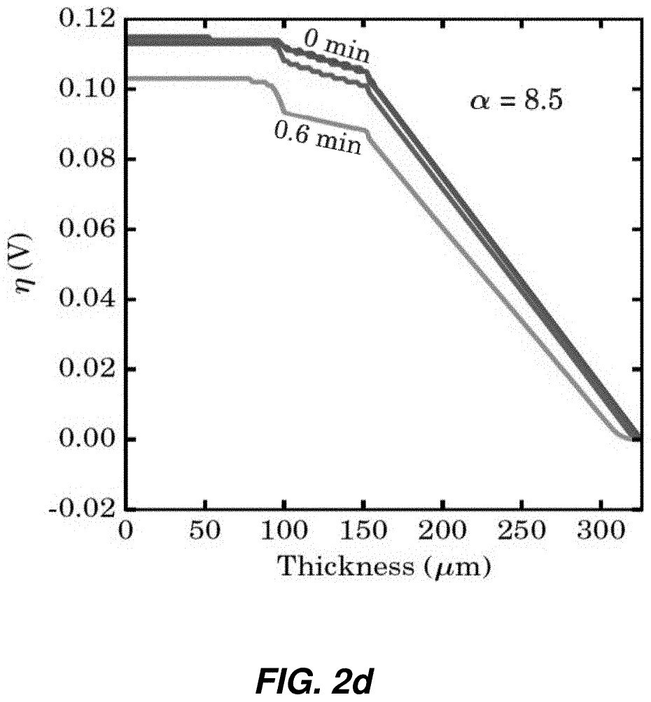

The effect of the Bruggeman exponent alone is summarized in FIG. 1 for a current density of 22.5 A/m2. In this section, A=3. Here, increasingly oblate particles display a sharp drop in energy density, indicating that a critical α˜6 exists above which tortuosity-induced losses dominates the system performance. At the microstructural level FIGS. 2a-2d show that as α increases the tortuosity-induced polarization losses increase, leading to an voltage drop across the thickness of the cathode, asymptotically reaching a maximum near α=6.5. In the anode layer, the voltage deviations from equilibrium decrease as a result of the transport limitations that develop in the cathode.

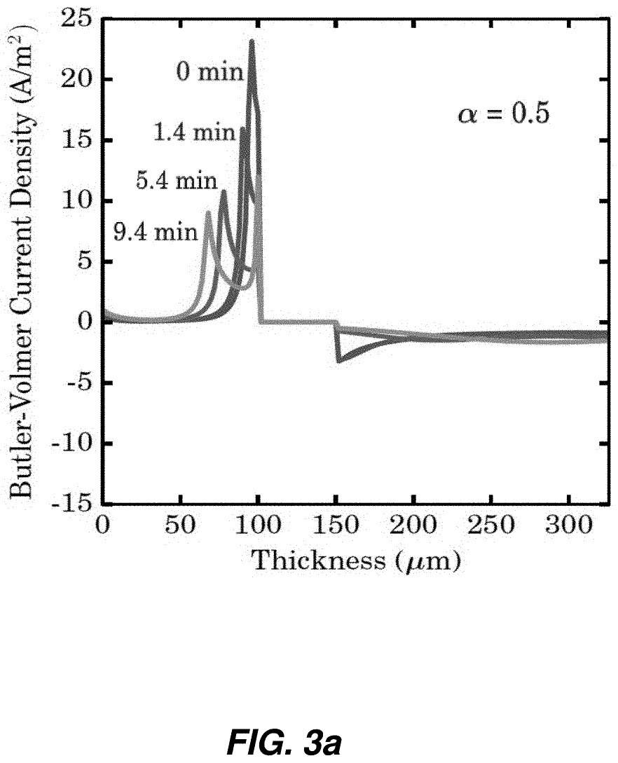

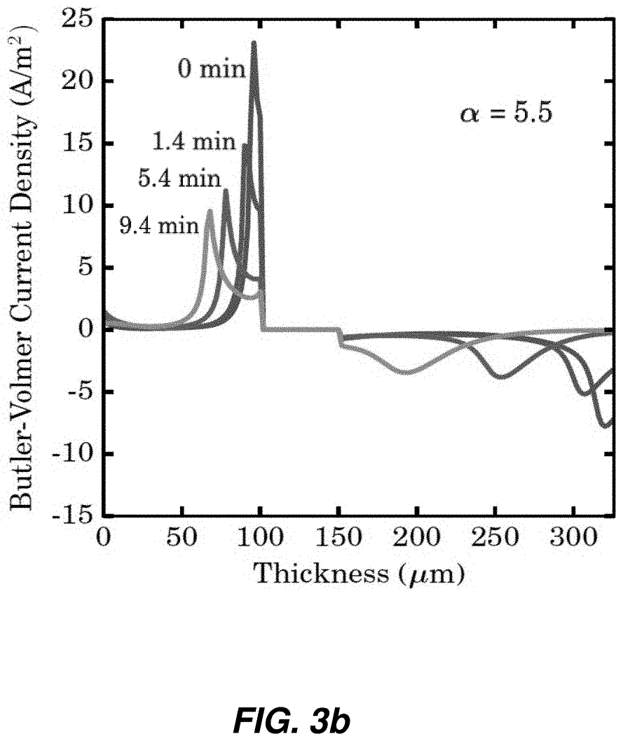

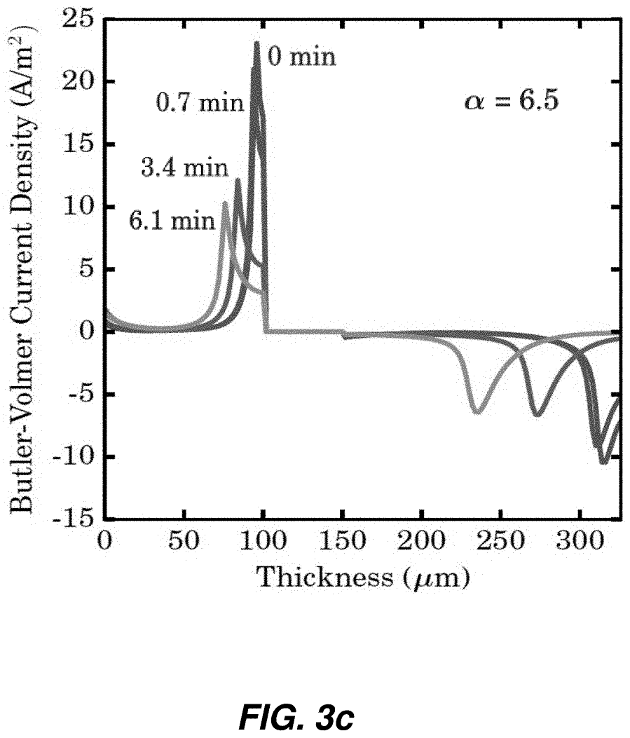

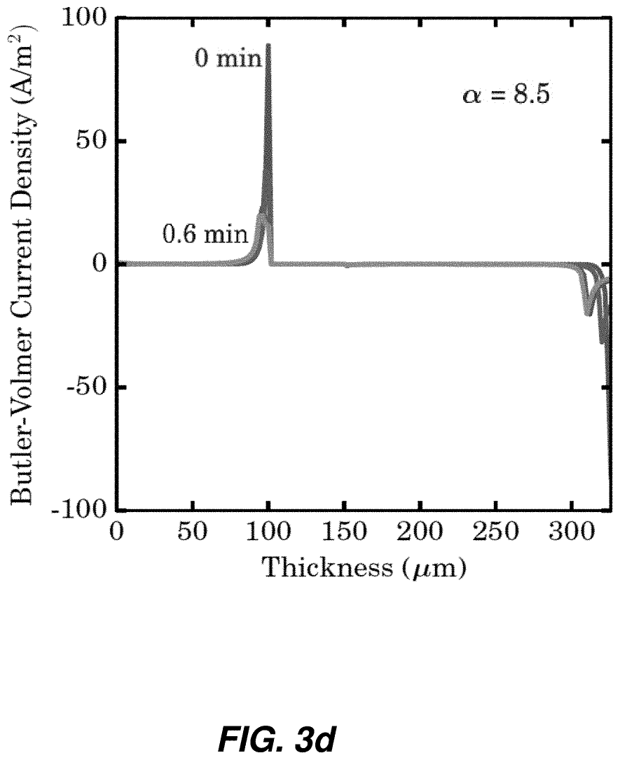

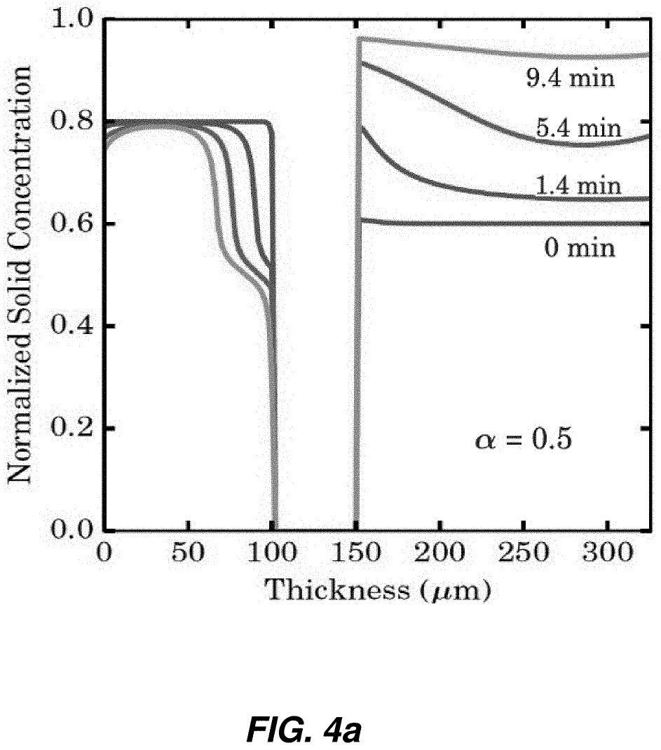

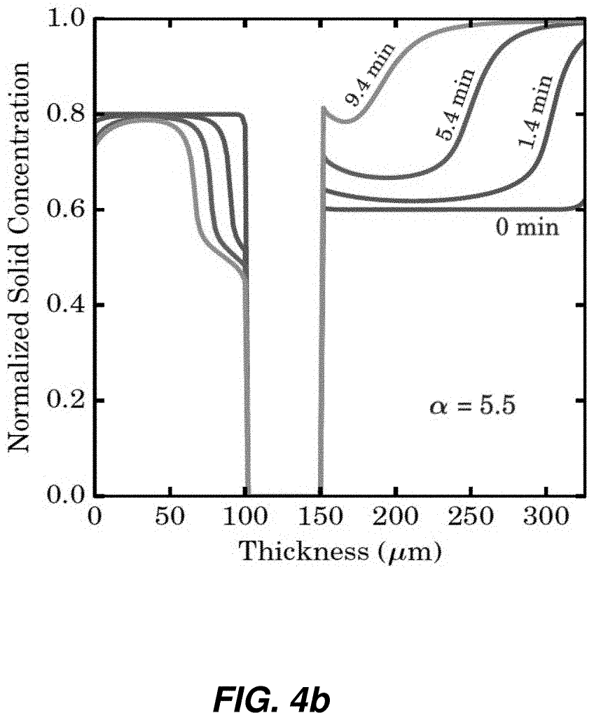

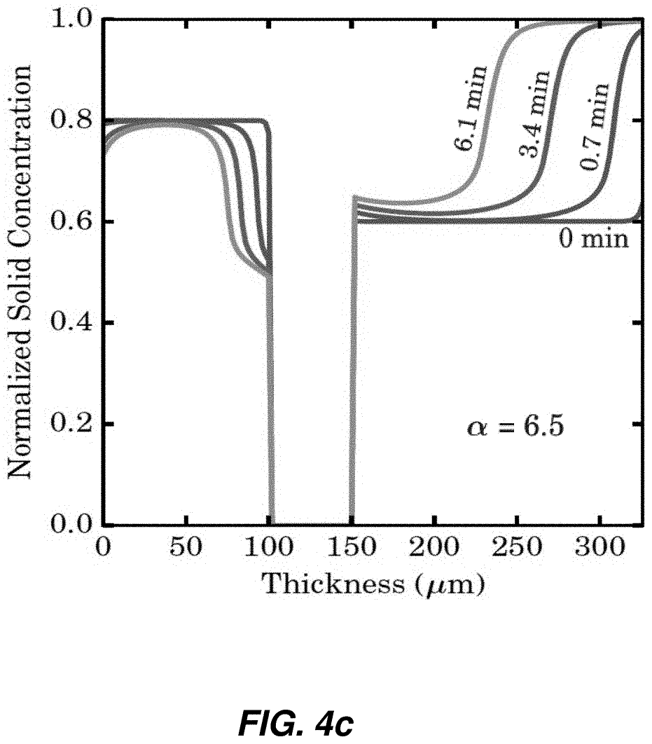

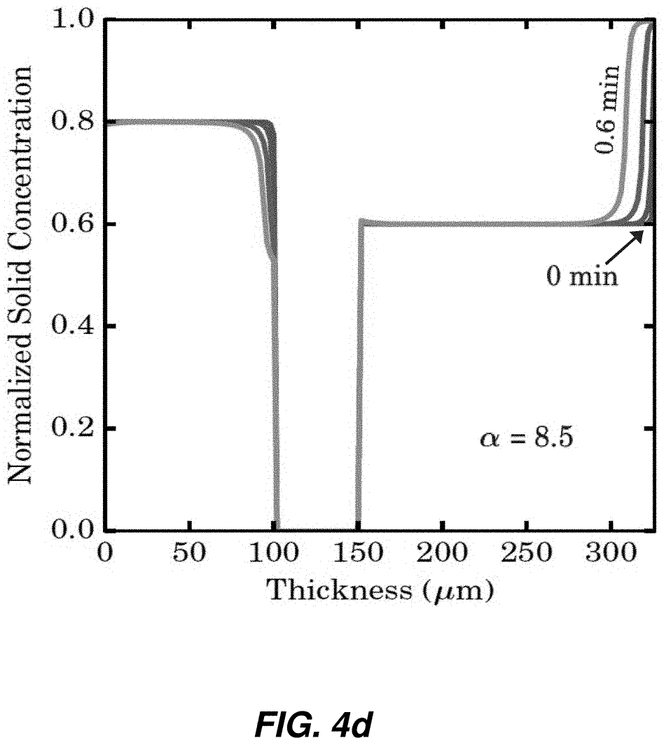

Calculations demonstrate that a decrease in the aspect ratio of the particles induces a shift in the local intercalation dynamics (see FIGS. 3a-3d). Here, the spatial distribution of Butler-Volmer interfacial current density in the cathode progressively shifts from developing the hallow and broad reaction zone that propagates from the separator-cathode interface to the back contact, to first becoming more localized and Gaussian-like in shape for intermediate α-values, to propagating in a retrograde fashion: from the back contact to the separator-cathode interface. In contrast, the intercalation dynamics in the anode get progressively suppressed, and a secondary reaction zone develops at the anode-back contact interface.

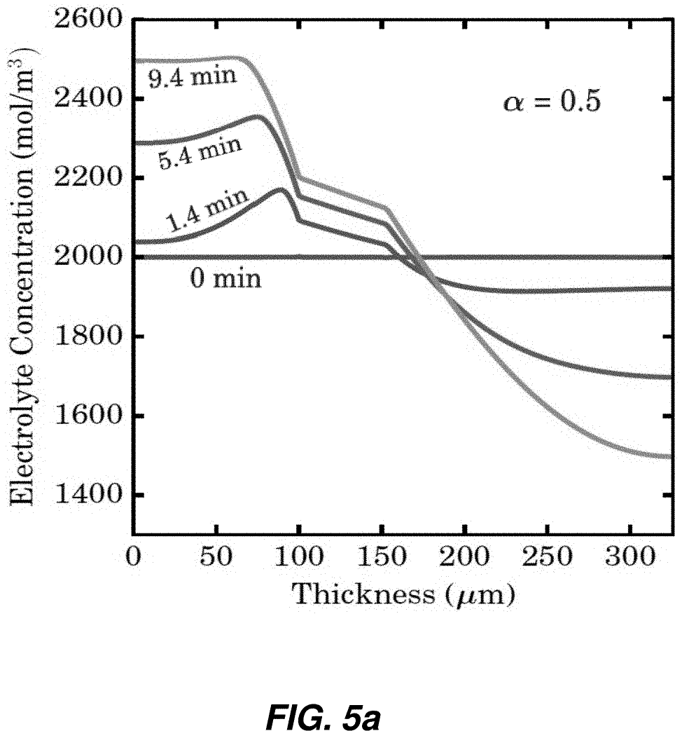

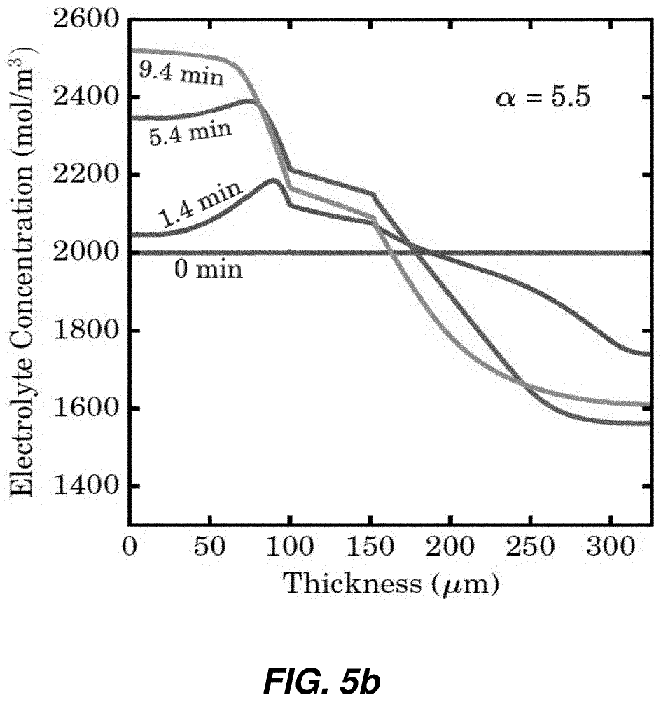

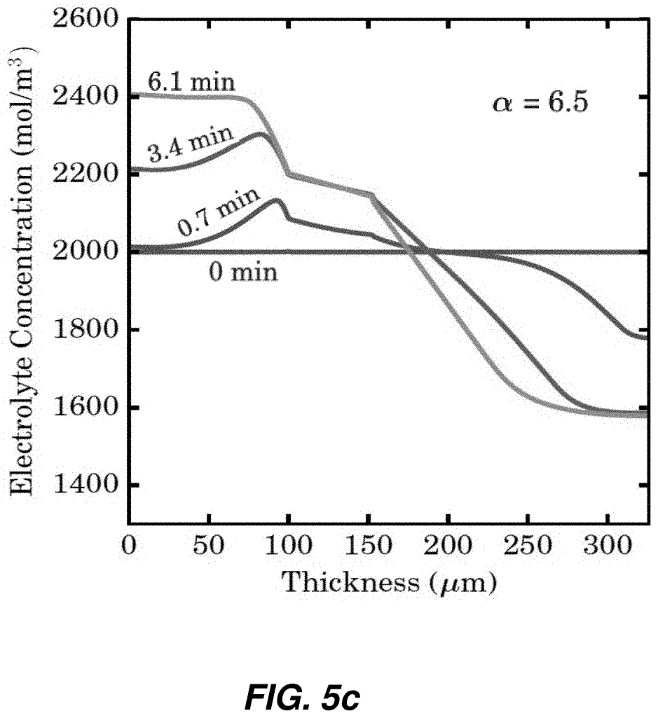

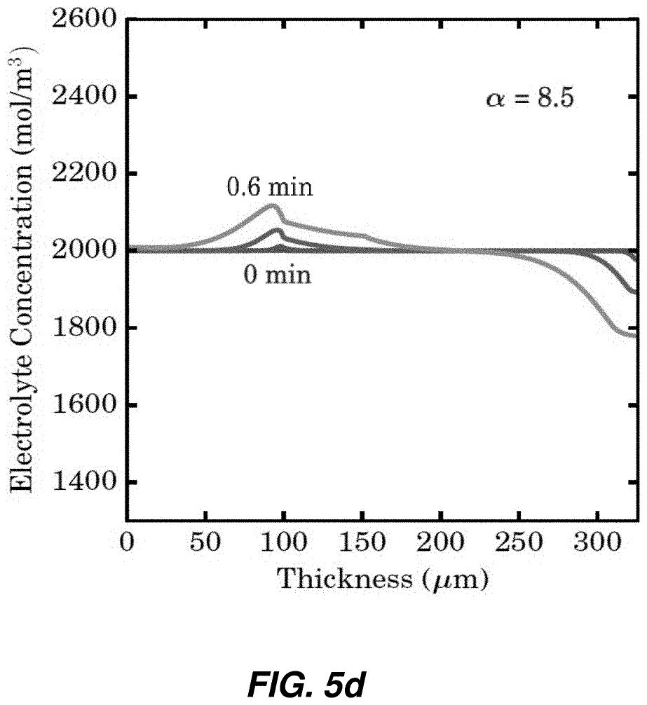

As a result of increasing the microstructural transport limitations in the cathode layer and the corresponding shift in intercalation dynamics, the through-thickness spatial distribution of intercalated material shifts from having a uniform intercalation with a localized front that propagates from the separator-cathode interface towards the cathode back contact to intercalating from the back contact towards the front of the electrode layer, FIG. 5. Moreover, in the limit of very oblate-shaped particles or α-values greater than the identified critical exponent, intercalation will be localized in the cathode back contact region. Mass deintercalation is balanced in the anode by leading to primarily utilize active material in the anode-separator region.

Similarly, FIGS. 5a-5d show that the lithium-ion transport limitations induced in the electrolyte phase by the increase in tortuosity leads to a progressively localized lithium depletion in the cathode layer. In the limit of very high α-values, lithium depletion primarily occurs in the back of the cathode layer.

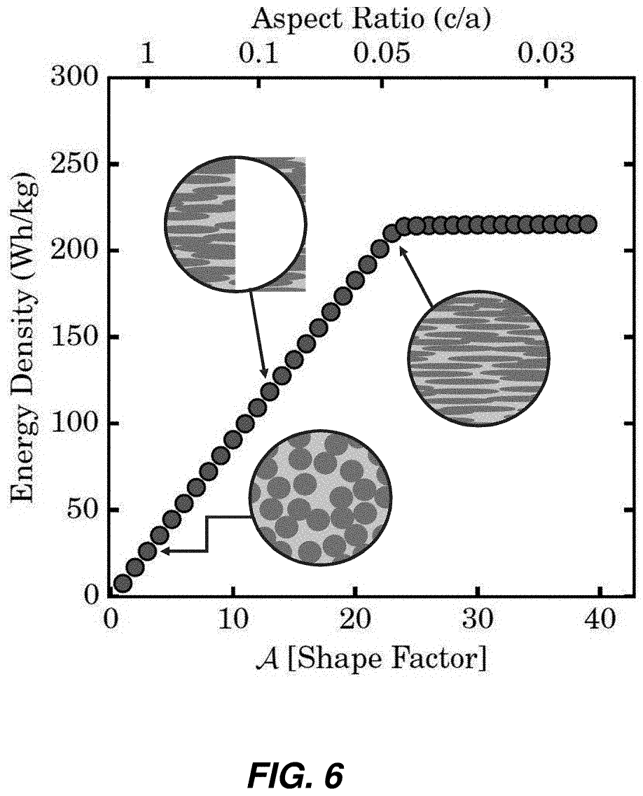

The effect of active material particle morphology anisotropy alone is analyzed by quantifying the effect of the shape factor as described by Equations 2 and 3 on the energy density, see FIG. 6, for a current density of 22.5 A/m². In this section, α=½. As intuitively expected, results demonstrate that there is a linear increase in the energy density as the area per unit volume increases up to a shape factor of A˜23 (or aspect ratio of (c/a)˜0.05), beyond which it levels off to a constant energy density of ˜215 Wh/kg. Leveling off occurs because the porous battery becomes diffusion limited further supporting the existence of a microstructureparticle morphology combination that maximizes its macroscopic, delivered energy density.

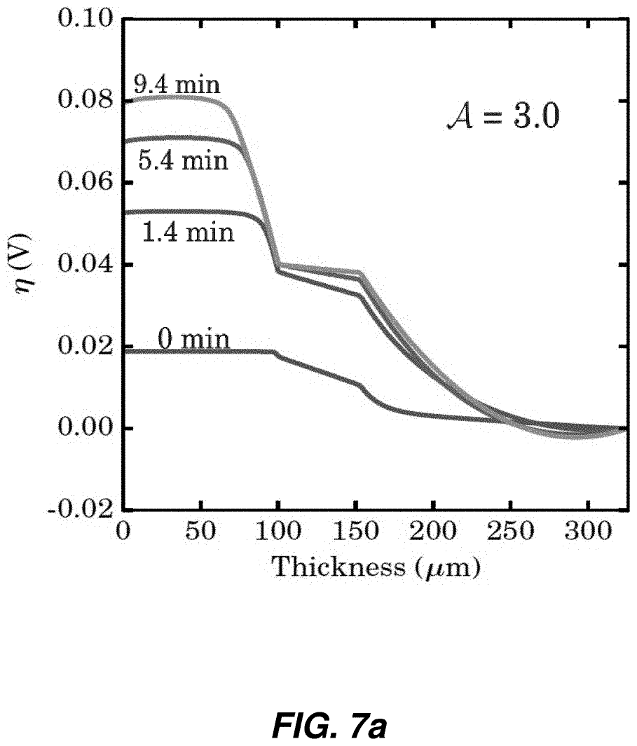

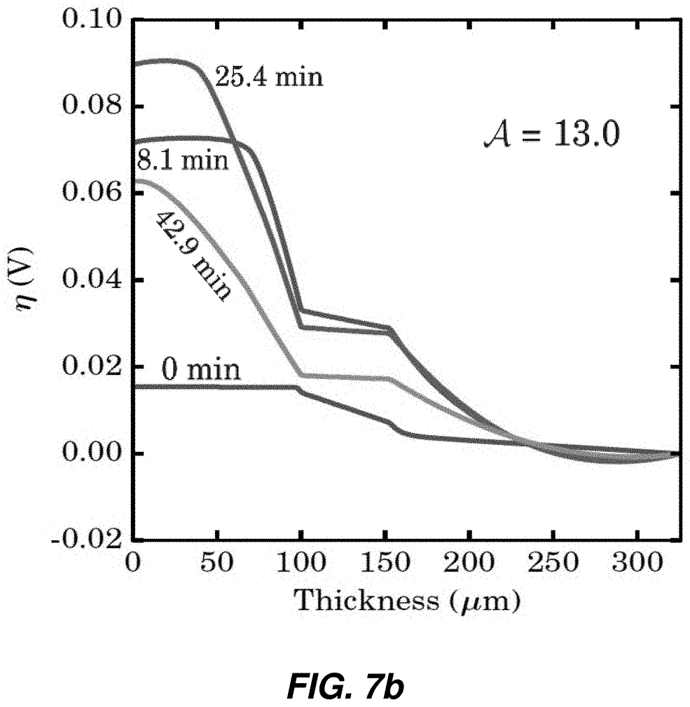

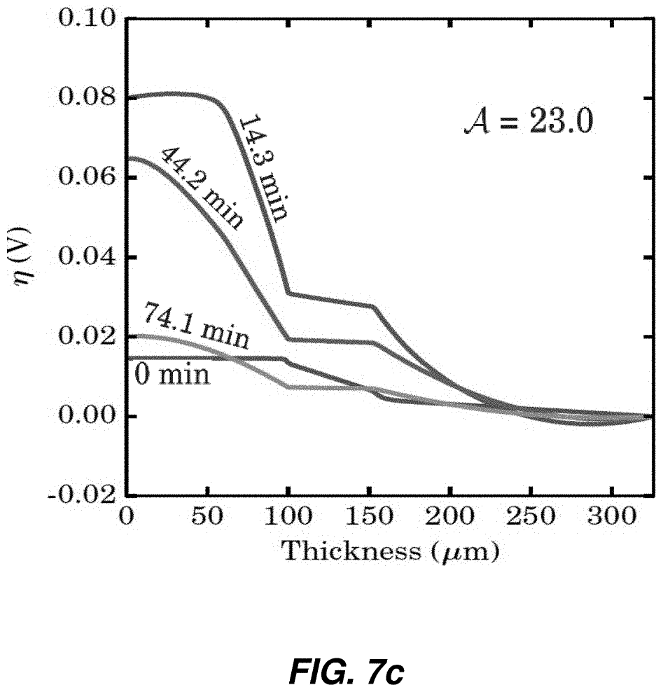

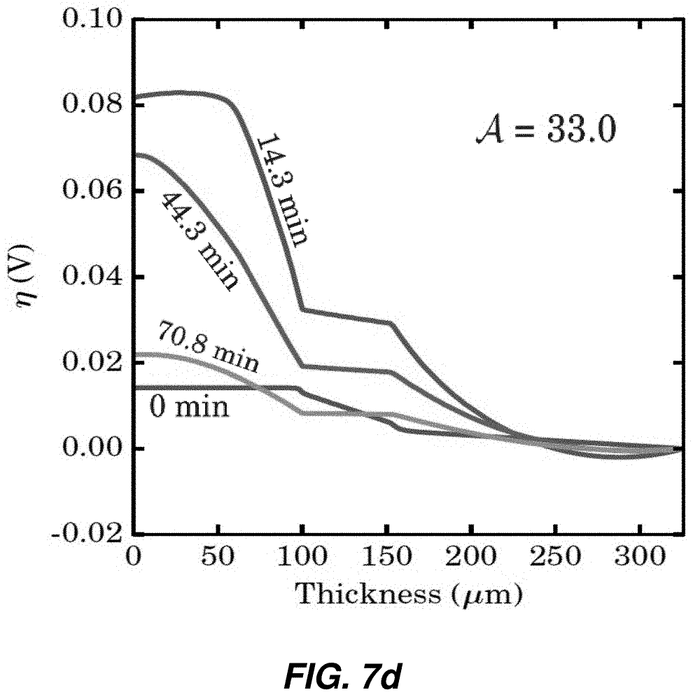

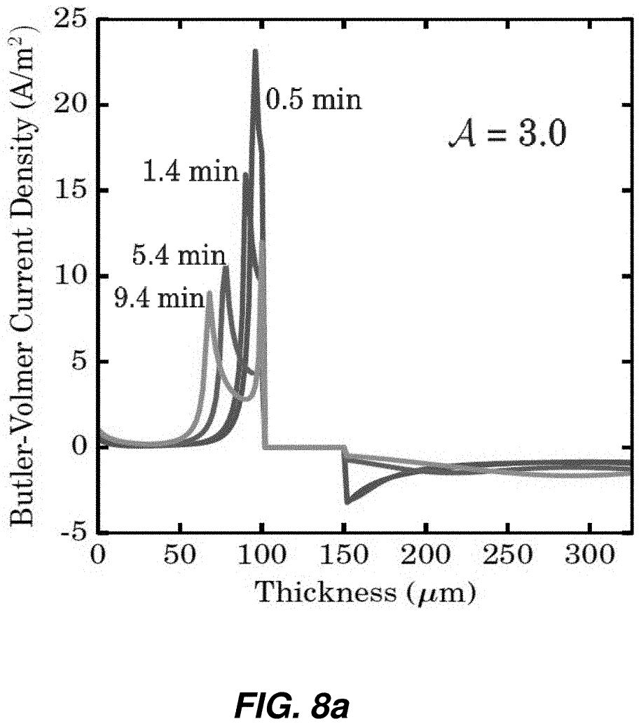

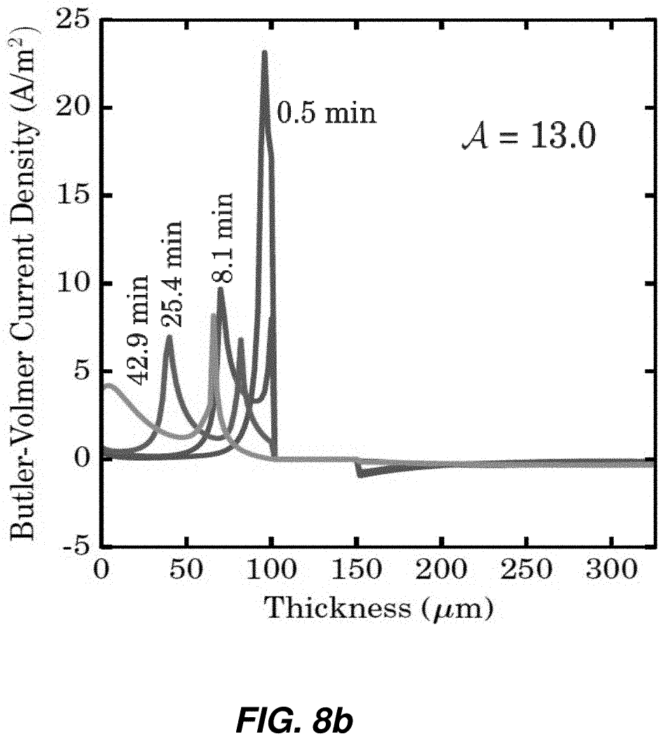

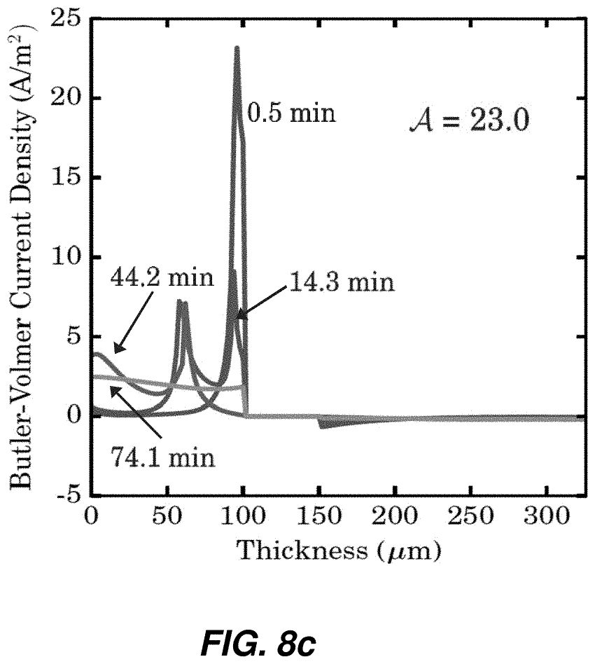

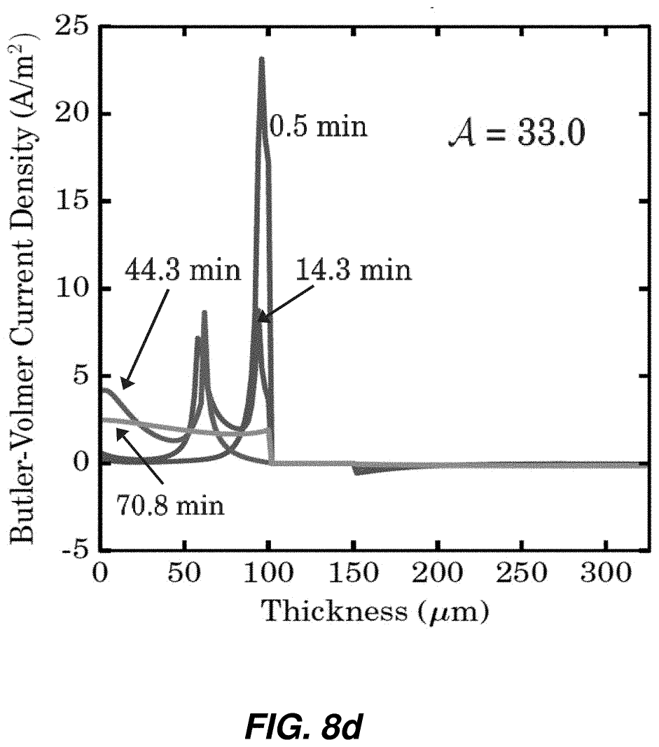

Inside the cathode layer, FIGS. 7a-7d show that as the shape factor increases, the voltage drop across the cathode layer decreases, shifting the overpotential drops to the anode layer. As the cathode particles become more reactive, the anode becomes the limiting component for it is unable to keep up with the intercalation kinetics of the cathode. FIGS. 8a-8d support this statement, as the reaction rate becomes uniform in the cathode and the anode develops a secondary peak that moves through the anode as lithium flows to the front of the anode in order to maintain the reaction in the cathode. The main reaction zone peak at the anode-separator interface remains unaffected in magnitude as the shape factor increases.

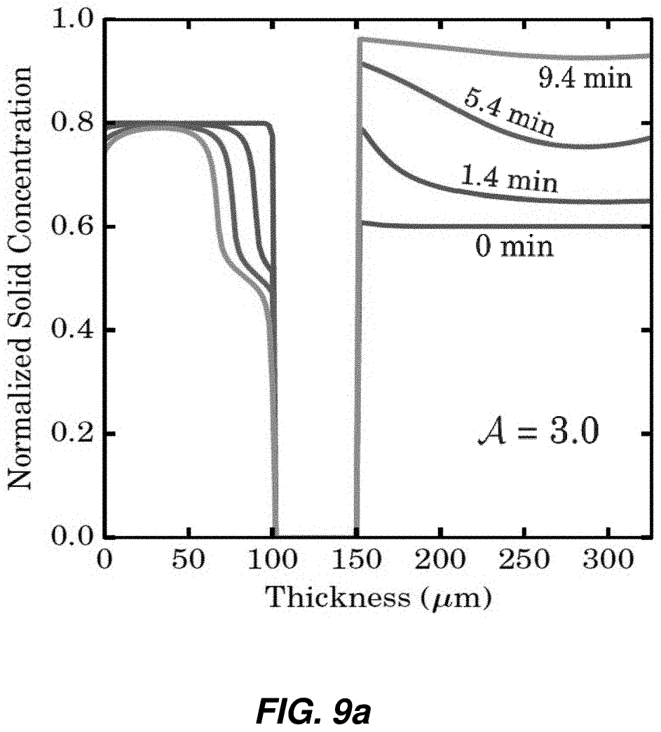

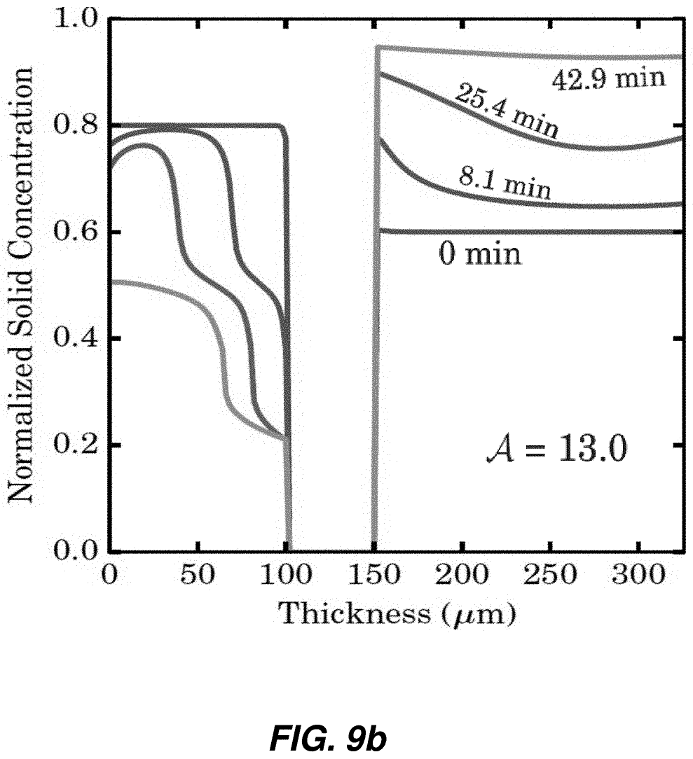

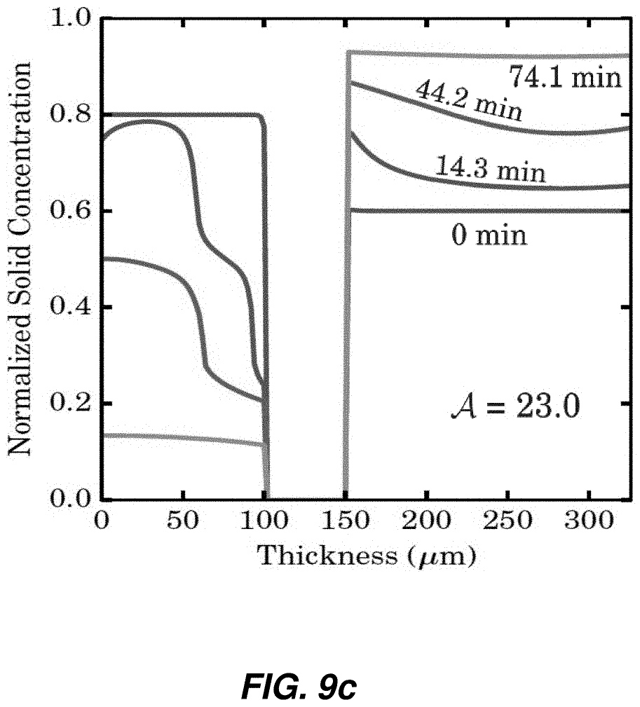

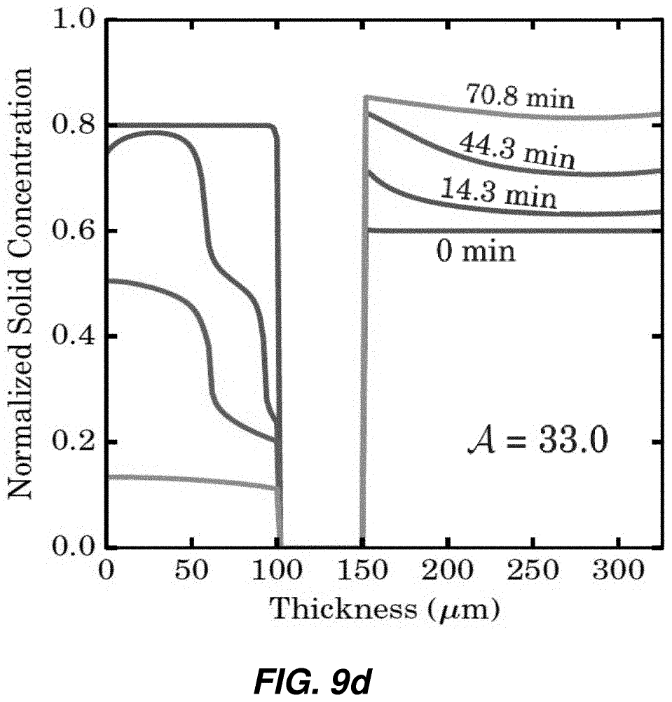

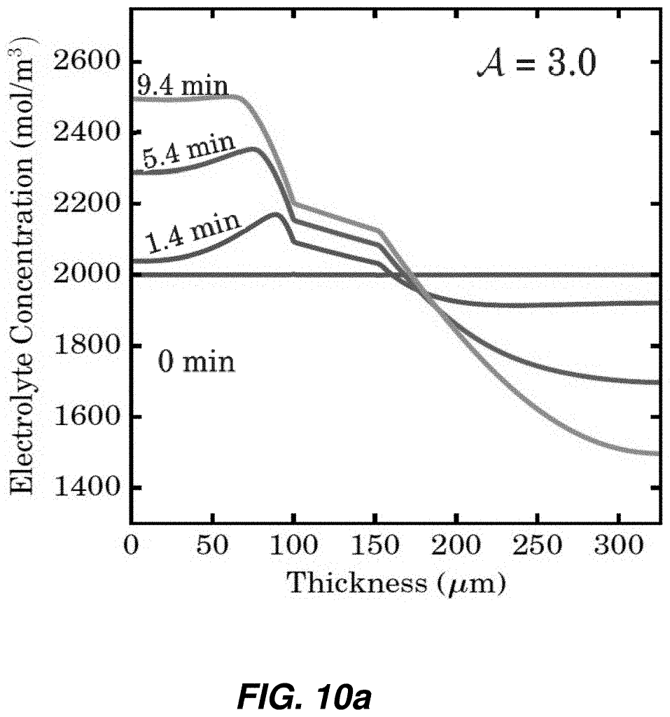

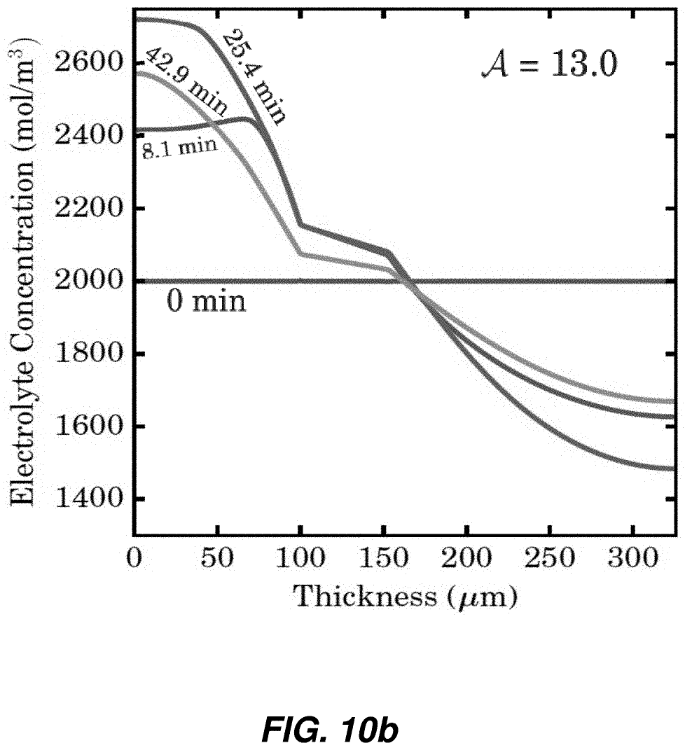

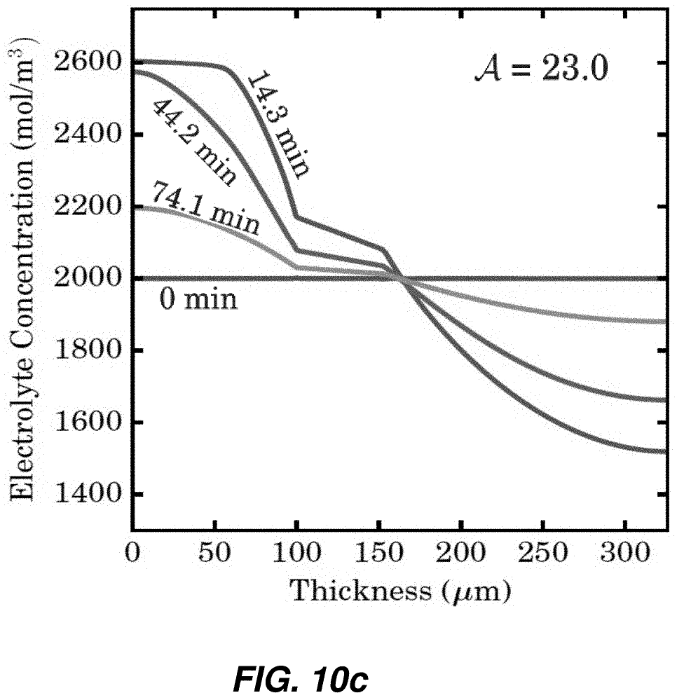

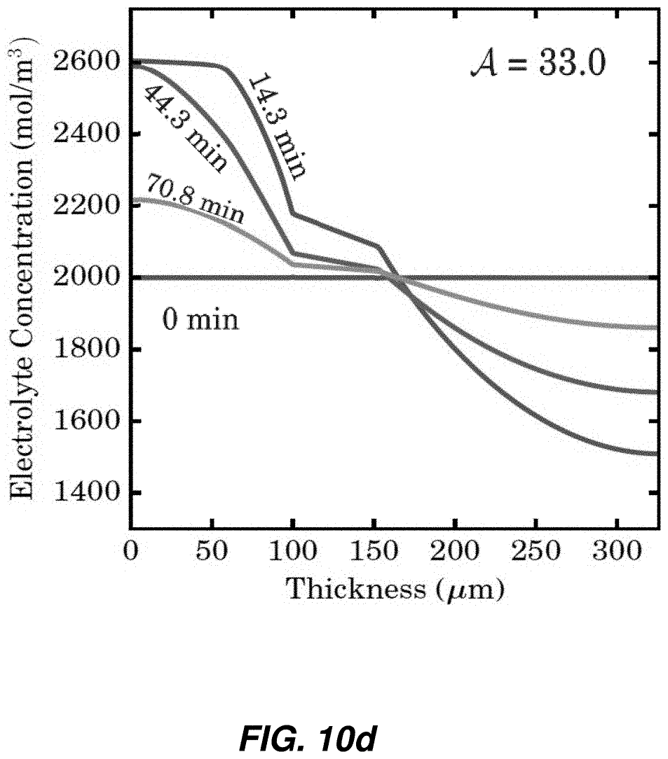

The spatial extent of intercalated lithium in the cathode remains qualitatively unchanged as the area density increases (see FIGS. 9a-9d); however, the discharge time becomes anode limited because the two reaction zones that develop in the negative porous layers. FIGS. 10a-10d show that the greater degree of deintercalation in the anode with increasing shape factor leads to greater lithium accumulation in the back of the anode and sharper concentration gradients, thus favoring the formation of SEI and dendrite growth.

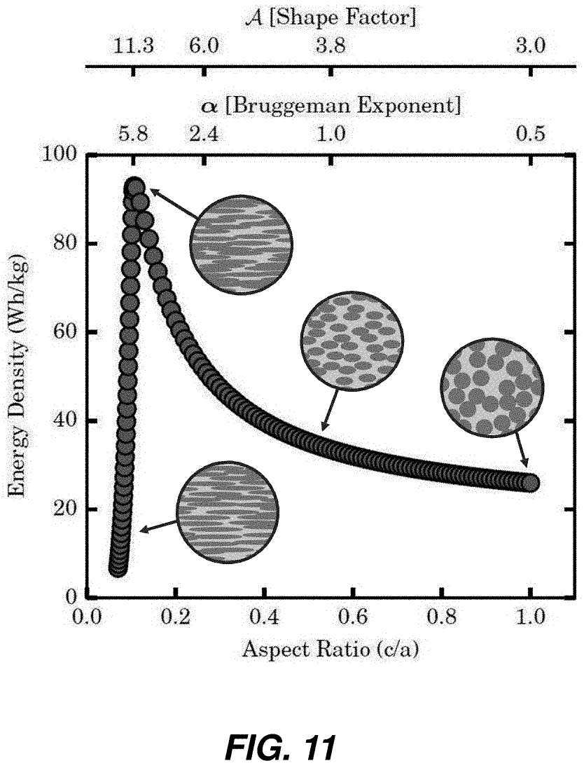

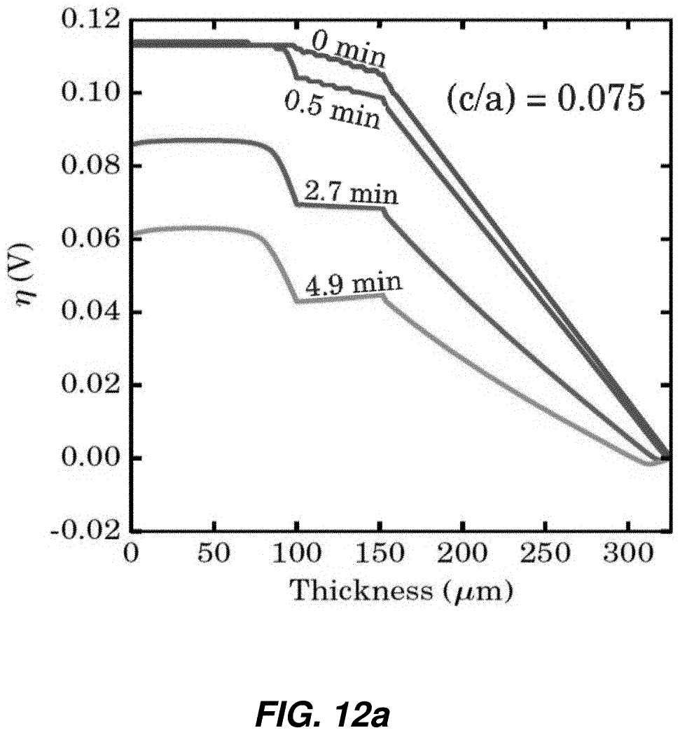

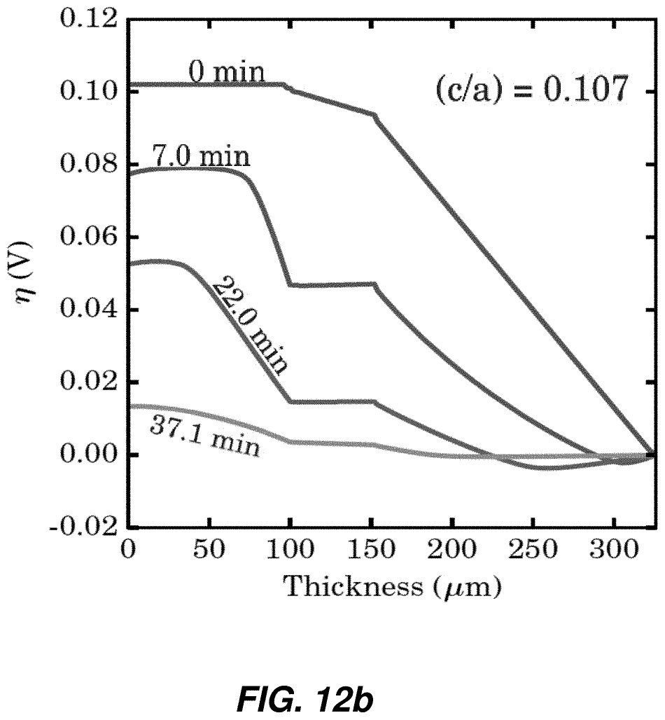

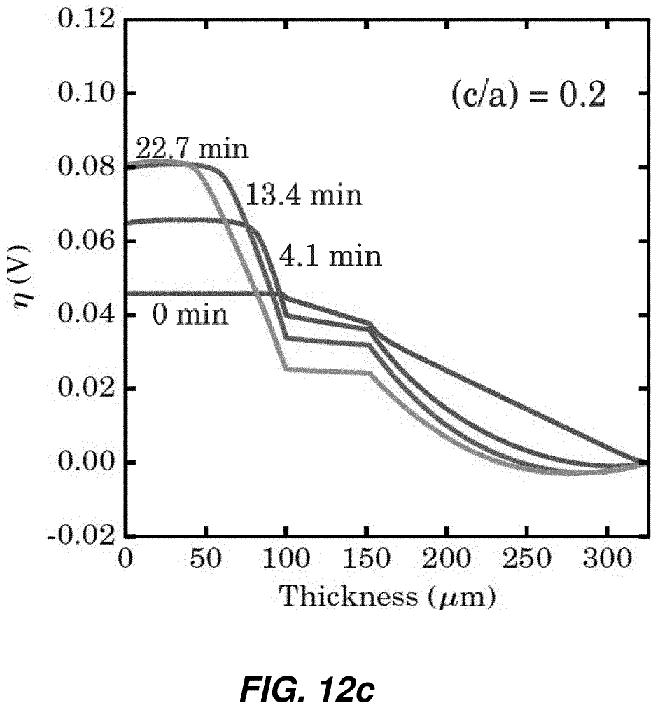

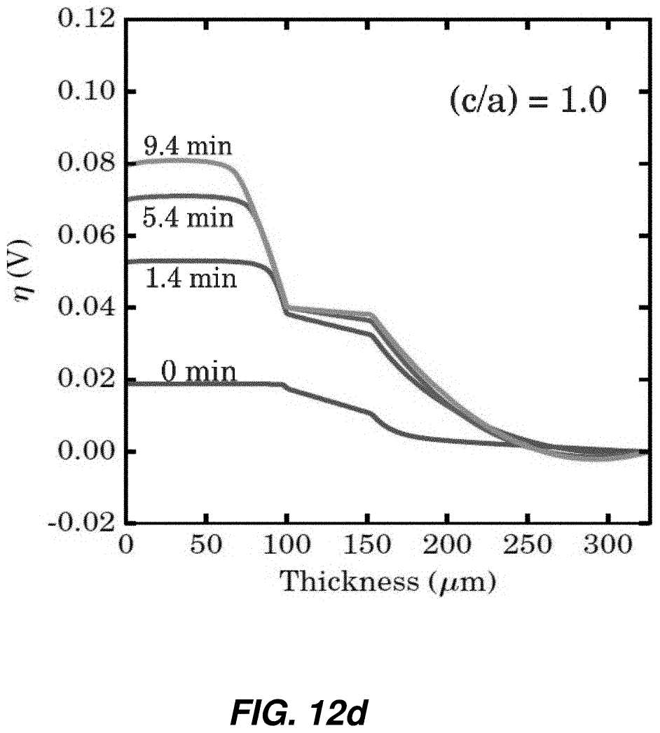

The combined effect of reactive area density and tortuosity on the cell's energy density is shown in FIG. 11 for a current density of 22.5 A/m2. Results demonstrate that as the particles become increasingly oblate, the macroscopic energy density increases as a result of the increase in area density, until it reaches a maximum at (c/a)˜0.107, to deliver an optimal ˜93 Wh/kg. Oblate particles with a smaller aspect ratio. (e.g., (c/a)˜ 1/20), the throughthickness polarization losses due to tortuosity are higher than the benefits provided by the increase in area density. . This energy density peak occurs well below the regime where the lithium transport properties of the electrolyte become limiting (see FIGS. 6 and 11). The effect of microstructure on the spatial; overpotential distribution is summarized in FIGS. 12a-12d where the onset of large voltage gradients induced by the increase of tortuosity in the cathode for oblate particles is delayed as a result of the increase of reactive area density. Moreover, for the optimal aspect ratio of c/a)=0.107, the overpotential in the electrolyte approaches its equilibrium (zero) value due to the high reactivity of the cathode particles, which is driving intercalation in combination with minimal losses. Oblate particles with an aspect ratio below the optimal (c/a) value further results in a dramatic increase of tortuosity induced polarization losses, which in turn completely suppress the delivery of any useful charge.

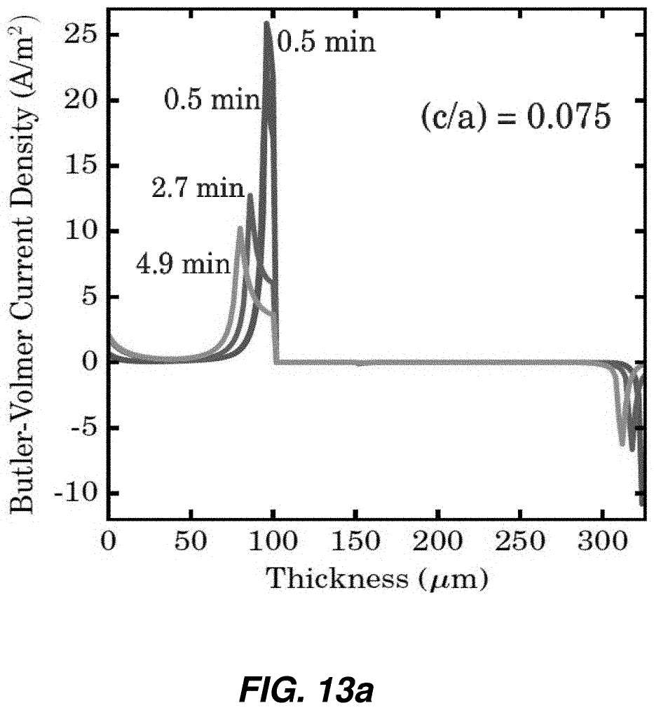

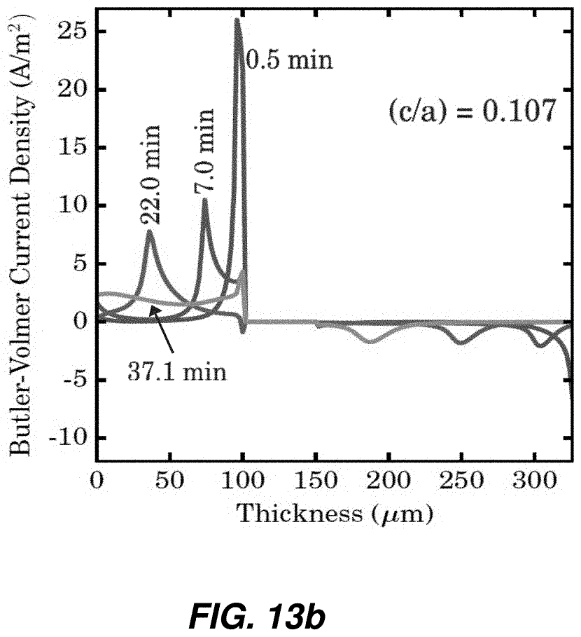

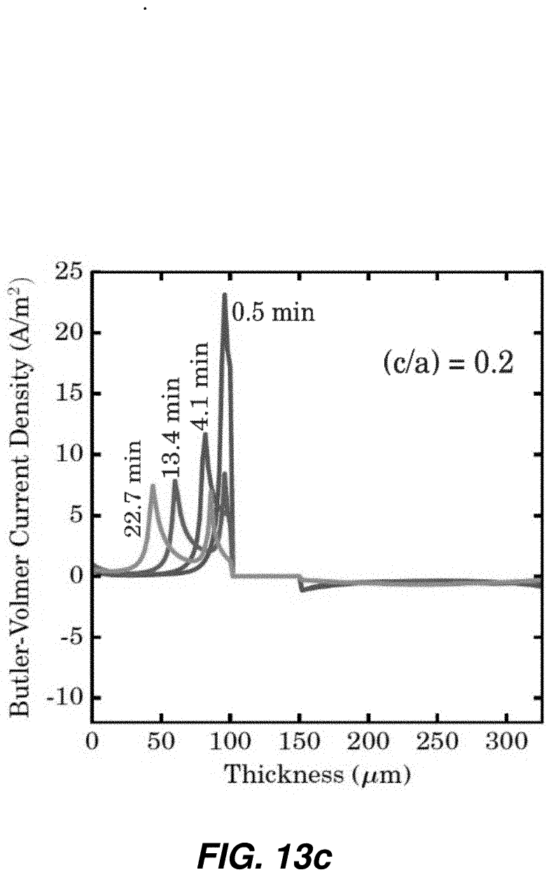

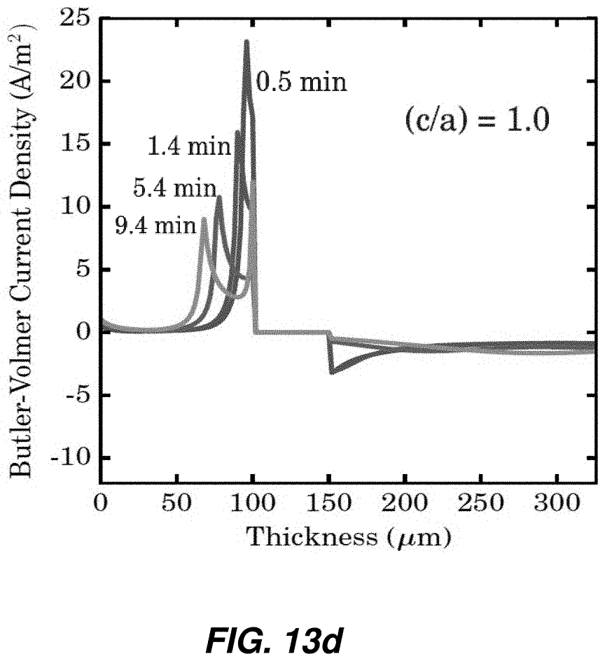

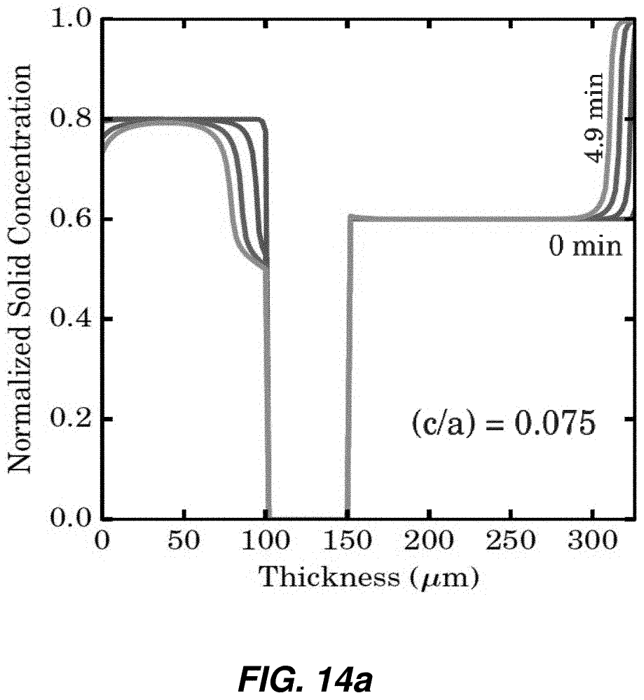

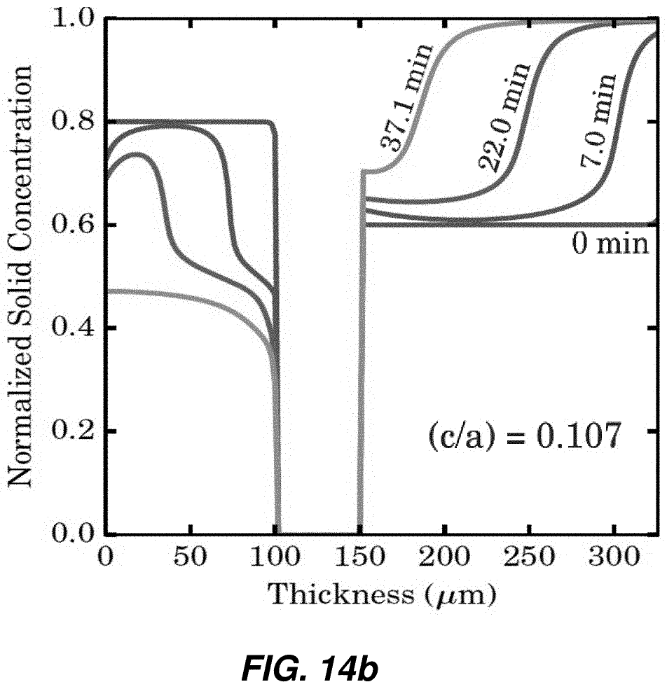

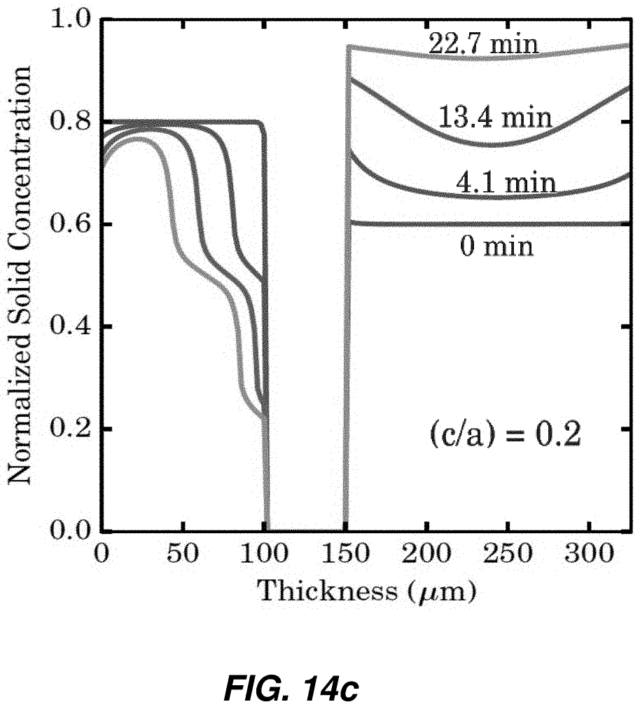

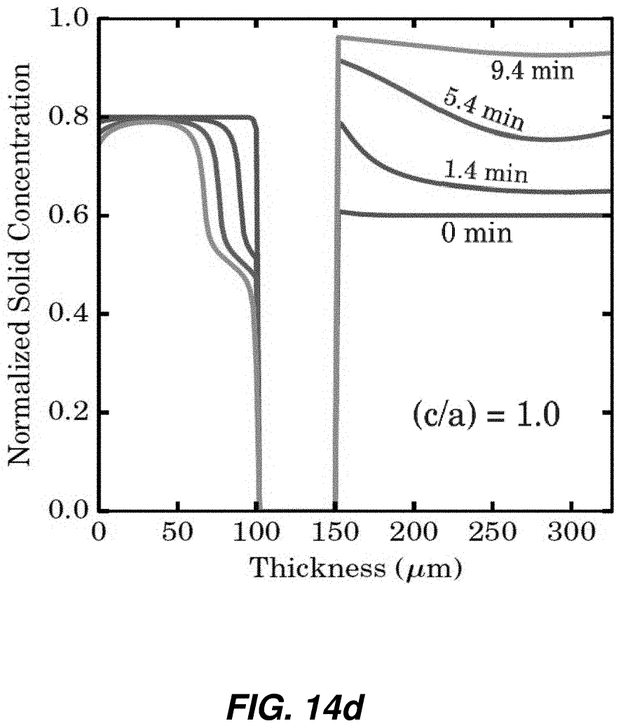

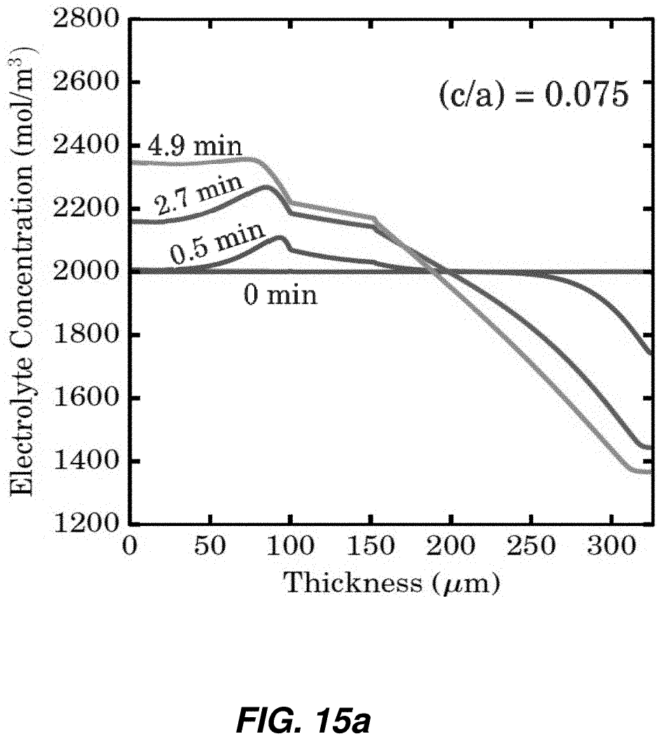

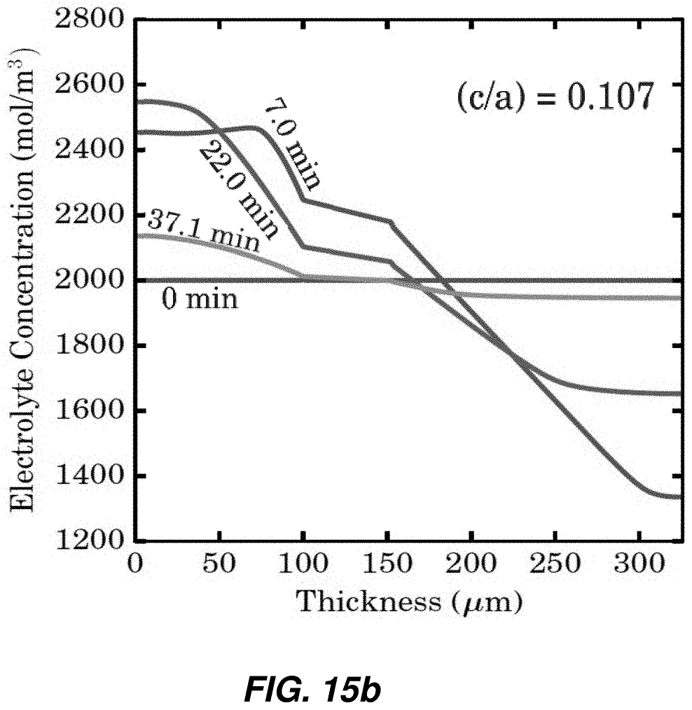

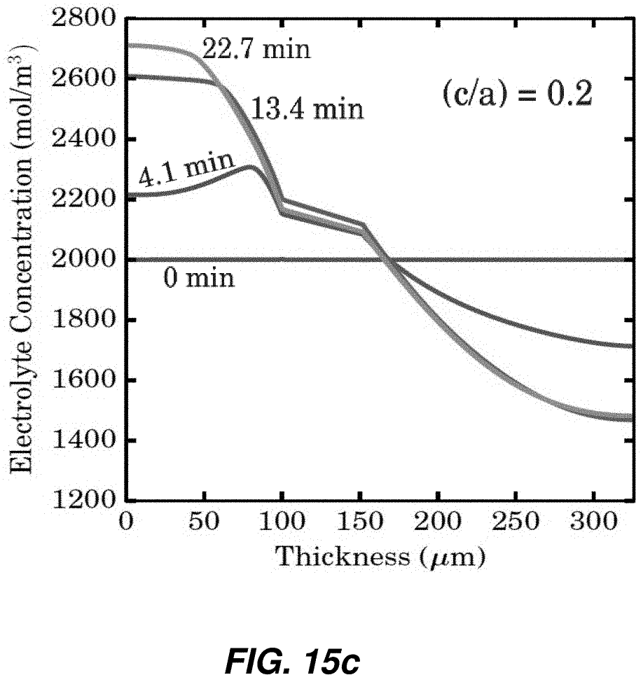

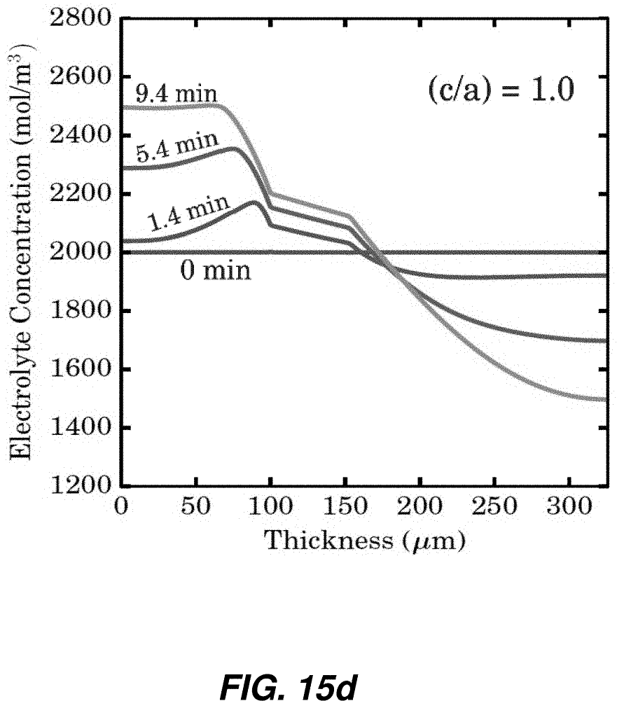

The effect of morphological anisotropy on the interfacial current density is summarized in FIGS. 13a-13d. Here, as perfectly aligned platelets become increasingly oblate, the reaction zone is qualitatively influenced by the increasing tortuosity of the porous microstructure, but the onset of the retrograde propagation of the reaction front (from the back contact to the separator-cathode interface),is delayed by the local increase of the reactive area density. The magnitude of the peak of the reaction zone is also lower. At the optimal aspect ratio ((c/a)˜0.107), the reaction zone in the both cathode and anode spread out across the layers, and while it is not uniform, it shows that it maximizes the utilization of active material. As particles become increasingly prolate, the volume fraction distribution of utilized cathode material changes from being uniformly distributed to intercalating from the cathode back contact to the front of the electrode layer (see FIG. 14a through 14c). For (c/a)-ratios smaller than the optimal value, lithium only intercalates in the vicinity of the cathode-back contact interface Similarly, the depth of deintercalation in the anode its the most uniform when it reaches the optimal (c/a) value. Away from the optimum, lithium deintercalates preferentially in the vicinity of the anodeseparator boundary. In the electrolyte phase, lithium depletion in the cathode layer is favored for spherical and very prolate-shaped particles, FIGS. 15a-15d. However, at the ideal (c/a)-ratio, deviations from its initial equilibrium value are small because transport and intercalation are in dynamic equilibrium. In the anode layer, lithium gradients in the electrolyte phase are minimal at the optimum particle morphology, suggesting that salt precipitation can be avoided at the optimum battery microstructure.

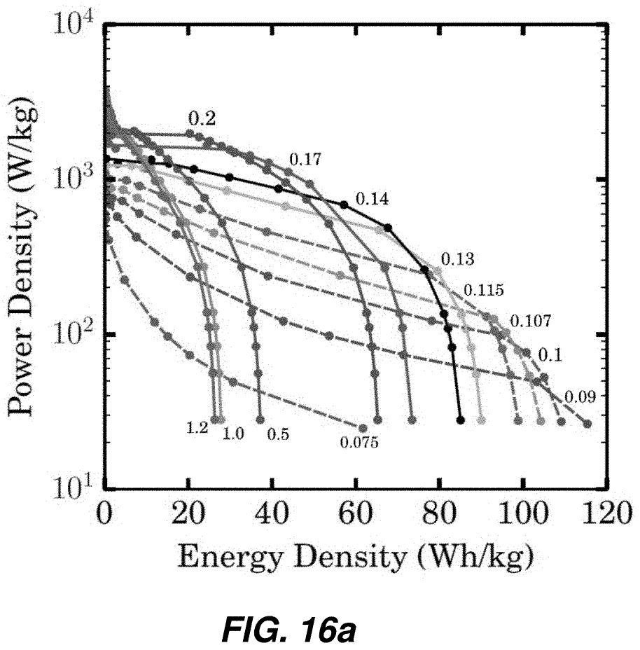

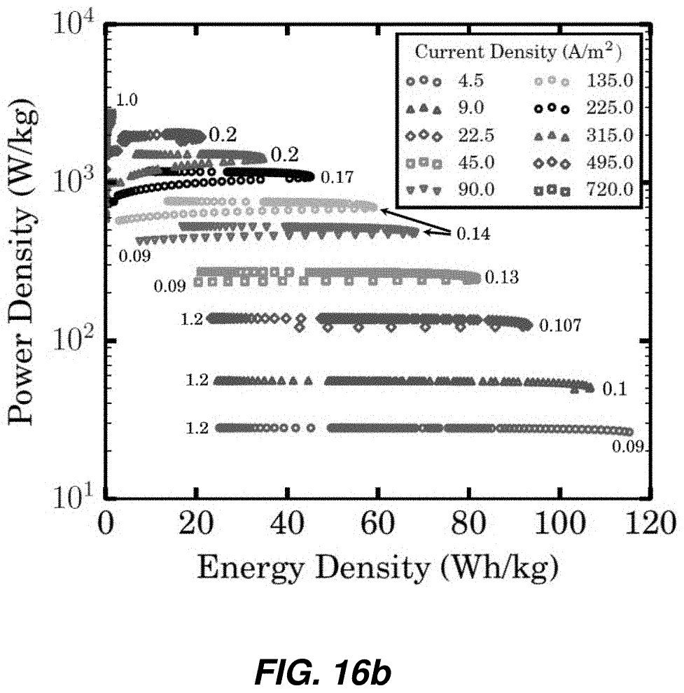

Overall, the analysis above demonstrates that, for fixed current density, at least one optimal microstructure morphology exists that maximizes performance. FIG. 16a macroscopic delivered power density as a function of energy density, for fixed microstructure. In general, (c/a)<0.09 will not deliver improvements neither in energy nor lower density because the aspect ratio is so low that the polarization losses due to tortuosity overshadow any possible area density enhancements. Qualitatively, this is in agreement with what has been observed experimentally in the literature. In contrast, for (c/a)>0.09, the resultant set of Ragone plots illustrate three primary types of response:

Alternatively, FIG. 16b shows that high aspect ratios that exhibit an optimal energy density response will drop significantly its capacity as the current density increases. Moreover, while an optimal microstructure exists for each current density, two types of microstructures can deliver the same (nonoptimal) energy density for the same power. The difference becomes more pronounced as particles become increasingly prolate. Moreover, for a specified current density, a worst microstructure exists that delivers the same power, but the lowest energy density.

The invention is inclusive of combinations of the aspects described herein. References to “a particular aspect” and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

1. A battery, comprising:
a) an anode; and
b) a cathode, the cathode comprising particles having an aspect ratio between 0.09 and 0.5.

2. The battery of claim 1, wherein the aspect ratio is between 0.09 and 0.107.

3. The battery of claim 1, wherein the aspect ratio is between 0.107 and 0.2.

4. The battery of claim 1, wherein the aspect ratio is greater than 0.2 and less than 0.5.

5. The battery of claim 1, wherein the particles are ellipsoidal.

6. The battery of claim 1, wherein the battery is rechargeable.

7. The battery of claim 6, wherein the battery is a lithium-ion battery.
